(19) United States
(12) Patent Application Publication
(10) Pub. No.: US 2009/0009346 A1
(43) Pub. Date: Jan. 8, 2009

(54) Portable Personal Alarm Device

(76) Inventors: Glenn Hojmose, Silkeborg (DK); Henrik Ditlev Kamp, Arhus (DK)

Correspondence Address: JAMES C. WRAY, 1493 CHAIN BRIDGE ROAD, SUITE 300, MCLEAN, VA, 22101, US

(21) Appl. No.: 11/664,965

(22) PCT Filed: Oct. 6, 2005
(86) PCT No.: PCT/DK05/00644

§ 371 Date: Aug. 17, 2007

(30) Foreign Application Priority Data
Oct. 8, 2004 (DK) PA 2004 01541

(51) Int. Cl. G08B 17/10

(52) U.S. Cl. 340/628

(57) ABSTRACT

The present invention describes a portable personal alarm device comprising: —a manually activable switch means; —a smoke and/or gas detector means; —a vibration and/or tilt detection means; —an audible and/or visible alarm indication means; —a power source; and—a control circuit where input from said switch means, said smoke and/or gas detector means are compared to predetermined relevant values and/or ranges and where said control circuit in response to input from said switch means, said smoke and/or gas detector means may activate said audible and/or visible alarm indication means by activating the corresponding means in the proper mode.

This invention relates generally to a portable personal alarm device which has a number of features which cooperate in order to provide the user with the sense of added comfort and security.

Due to its size, aesthetic pleasing design and combination of inventive features, the invention provides a device which for many users will be a natural part of the equipment, people carry around in line with mobile telephones, PDAs, glasses etc.

### BACKGROUND OF THE INVENTION

There is a variety of different types of security devices currently available. For example personal security systems detect the presence of motion and turn on lights or deliver alarm signals or both. Smoke detectors detect the presence of smoke and deliver alarm signals.

An example of such a device is known from U.S. Pat. No. 5,309,145 which describes a device comprising a motion detector, ambient light sensors, smoke detectors, mode switch, alarm switch, clock, alarm switch clock, control switch and smoke detector switch. The information from all these sensors are used as input for a micro processor which according to the input provides current for a lamp which will then light the immediate vicinity of the device or an alarm which will send an audible signal. Furthermore, a clock display is provided such that the device may operate as an ordinary alarm clock. This prior art device is designed in order to be used for example in a hotel room having features being able to detect whether or not intruders enter the room (movement detector) or smoke is present in the room. In response to these detections, the micro processor will instigate an alarm signal or create illumination in the vicinity of the device by the lamp means.

The micro processor is used to control the timing of for example the alarm and the lamp as well as the audible alarm. Furthermore, a time circuit is incorporated in the micro processor which provides the functionality for the device to work as a common alarm clock.

Although this device provides a number of advantageous features, it also has some superfluous features as well as some drawbacks which users otherwise may encounter during every day life. The device also lacks some useful features which could provide a user with added security. The superfluous features are for example the clock and alarm in that most mobile phones will be able to provide for wake up calls or the installations in the hotels or lodgings will comprise for example in house telephone means or television circuits which will be able to provide alarm calls in order to wake up.

### SUMMARY OF THE INVENTION

One of the objectives of the present invention is therefore to provide a device which has more useful features and due to its inventive design also makes it possible to be used in a number of different situations in order to provide an added sense of security and thereby comfort for a user.

The present invention addresses this by providing a portable personal alarm device comprising:
a manually activable switch means;
a smoke and/or gas detector means;
a vibration and/or tilt detection means;
an audible and/or visible alarm indication means;
a power source; and
a control circuit where input from said switch means, said smoke and/or gas detector means are compared to predetermined relevant values and/or ranges and where said control circuit in response to input from said switch means, said smoke and/or gas detector means may activate said audible and/or visible alarm indication means by activating the corresponding means in the proper mode.

The manually activable switch means incorporated in the inventive design makes it possible for a user to instantly activate the audible and/or visible alarm indication means such that if for example the user feels threatened and carries the device in a pocket or in a handbag, the user may very quickly activate an alarm which may bring attention to the threatening situation from bystanders or law officers.

The vibration and/or tilt detection means may be used in a number of circumstances for example if the device is left in a bag, the vibration and/or tilt detection means may be activated such that if the bag is removed without shutting the vibration and/or tilt detection means off, the movement of the bag will activate the alarm and draw attention to the potentially unauthorised removal of the bag. Also for example in hotel rooms or the like by attaching the inventive device to the door, a slight movement of the door will tricker the vibration and/or tilt detection means and thereby activate the alarm and make the user aware that a possible intruder is trying to enter the room. Depending on the sensitivity of the vibration and/or tilt detection means, the device may also alert the user to a possible earthquake. In a number of regions in the world, earthquakes are quite frequent and as such not noticed by the local inhabitants. For travelers however, who originate from regions where earthquakes are quite unusual, the earthquakes might give rise to fears due to this unknown phenomenon. Therefore, by activating the vibration sensor, users originating from areas not prone to earthquakes and visiting areas where earthquakes are quite frequent may find an extra security in the fact that they have activated a device which will for example wake them during the night in case of an earthquake such that they may take the proper measures in order to avoid the detrimental effects from an earthquake and as a consequence for example leave the hotel or the like.

The control circuit may comprise a micro processor or other means for registering input and generating the corresponding output. The micro processor may be mounted on a PCB together with other components of the device.

The smoke detector might be of the optical type where a light source emits light towards the light sensitive diode, and if the light intensity changes, this is an indication of smoke being present in the field between the light emitter and the light detector. This will cause the smoke alarm to be activated. Other types of smoke detectors may also be used, for example radioactive detectors.

The smoke detector will activate the audible alarm and/or the visible alarm for example in the shape of stroboscopic lights such that in addition to indicating to the user of the device that there is a smoke hazard and thereby awakening the user, it will also provide the user with guidance to where the portable personal alarm device is situated in the room. This is important in that for example if the device is used in a hotel, the portable personal alarm device may be attached to the door and by alerting the user to the presence of smoke and at the same time creating a stroboscopic light, it will guide the user towards the door and thereby a possible escape route.

The smoke detection means may further comprise a further light detection device such that the smoke detector means may compensate for the presence of ambient light which causes traditional smoke detector means to tricker at inconvenient times. If there is a sudden change in the ambient light, this may give rise to a false alarm signal which is very inconvenient for a user. The sudden changes in light may occur for example where a user staying in a hotel room close to flashing neon signs or roads and the like where headlights from cars may give sudden flashes in a room where the user is staying. Furthermore, as the personal alarm device is portable and therefore may be carried in a bag or pocket, the device may be programmed such that the smoke detector is armed even without the user being aware of this. As the bag is opened or the user enters the dark room or leaves the dark room into a room with very much light, this may tricker the portable personal alarm device which may be very inconvenient for the user.

By programming the control circuit such that it will compensate for ambient light by means of having a further light detecting device outside the smoke detector means, all these inconvenient situations may be avoided.

In a further advantageous embodiment, the manually activable switch means may be biased towards a rest position and when manually depressed an input is registered, and further such that the control circuit may be programmed in a manner where different input may be generated by the number of times the switch means are activated.

Where other devices comprise a number of separate buttons and switches in order for a user to initiate the different alarm modes and deactivate them again, the present invention may use the presence of the control circuit and the biased switch means be programmed such that 1, 2, 3 or more clicks may activate a different or a plurality of detector means in the device depending on the number of clicks, i.e. the number of times, the biased switch means has been depressed.

In a further advantageous embodiment, a single depression may activate the audible and/or visible alarm, and that optionally the activation may be delayed 1 sec. to 5 sec. after depressing the switch means, or alternatively a longer depression of the switch means for example lasting 2 seconds or more will activate the audible and/or visible alarm instantly. This embodiment is particularly useful in versions of the portable personal alarm device where it is desirable to build in a personal alarm such that if a user feels threatened or is being attacked, depression of the switch means for example lasting two seconds or more will activate the audible and/or the visible alarm. These situations and in particular the generation of an extremely loud and clear alarm signal will deter the attackers and hopefully indicate to bystanders that something is amiss which may cause them to interfere and thereby help the user of the portable personal alarm device.

In a further advantageous embodiment, the audible alarm may be a loudspeaker, for example a piezo electrical element, where said audible alarm emits noise corresponding to a loudness of 85 dB at 3 meters distance. Tests have shown that the piezo electrical element is able to emit signals at 85 dB or more such that an extremely loud noise will be generated when the audible alarm is activated. This is important in all situations where an alarm signal needs to be generated in that in cases where the smoke detector generates the alarm usually the user will be asleep or where the vibration and/or tilt detection means are activated, for example when the alarm is used to protect a bag placed in a stationary situation, the very loud alarm signal will alert bystanders to the fact that a bag has been removed and as the person who removed the bag is followed by this very loud noise, it will be fairly easy to pursue the person who has removed the bag. At close range, the noise pressure from 85 dB is at a threshold where it may alert bystanders which is very effective when the alarm device is used as a personal alarm device in case of a mugging or threatening behaviour from persons.

In a still further advantageous embodiment of the invention, a transponder is provided inside the device such that when the switch means has created the correct input in order to activate the vibration and/or tilt detection means the transponder is activated.

In many areas around the world, networks are provided which may detect a signal emitted from a transponder. Therefore, if the transponder built into the portable personal alarm device is activated in connection with the vibrations/tilt detection means, an audible alarm may not necessarily be generated, but the signal from the transponder will be emitted such that it may be possible to track the alarm device. If the alarm device is stored in a suitcase, handbag or the like, it will in this manner be possible to pursue the alarm device and thereby the lost luggage or stolen handbag, and eventually hopefully catch up with the luggage or handbag. In this connection, it should also be mentioned that in addition to activating the transponder, the vibration and/or tilt detection means may naturally also activate the audible and/or visible alarm indication means.

The visible alarm indication means may in a further advantageous embodiment be a stroboscopic light source, a flashing laser diode or other suitable low voltage light emitting device.

In order to provide the user with information about which mode, i.e. which detection means or other modes, the personal alarm device has been activated in, an audible signal is generated each time the switch means are activated and/or one or more LED's are illuminated corresponding to the number of times the switch means are activated. As the principle of the present device is to provide a device which is relatively small and handy, it will in preferred embodiments be provided without a display. Therefore, by illuminating one or more LEDs in order to signal the user which mode(s) is/are activated, this will give a clear and easy indication of the mode of the device. In this connection, it should be contemplated that LCD displays or OLED displays may be incorporated into the device in order to provide the user with information on the state which the device is programmed in.

In a further advantageous embodiment, the control circuit may comprise a power monitoring circuit such that an alarm, either audible or visible, is generated when the power level is below a certain predefined limit. The alarm or the indication by flashing the LEDs or for example changing the colour of the LEDs will indicate to a user that it is necessary to replace or recharge the power source. In some embodiments, it is foreseen that the power source is rechargeable and is therefore provided with an interface such that for example the same type of charger which is used for mobile phones may be used in order to recharge the power source of the portable personal alarm device. In some cases, the power supplied by the charging device is not sufficient and the control circuit is in these instances provided with converters such that the power transferred to the rechargeable power source is converted to the correct voltage.

One particular embodiment of the invention for such an alarm device where the device is arranged in a housing in the general shape of an elongated cylinder, where said cylinder may have a constant cross section or may have varying cross shape, wherein said cylinder is divided into five distinct zones, wherein:
in a first zone the switch means are arranged where a portion of said means extends outside said cylinder, and where optionally a LED may be arranged in the switch means;
in a second zone the power source and necessary control circuitry is arranged, and where optionally the second zone is delimited by a circular cylinder in which cylinder one or more LED's may optionally be provided such that illumination of said LED's may be detected from the outside indicating the mode of the device;
in a third zone three or more LED's are provided in a cap member, which cap member is a transition collar between the second zone and the fourth zone, and that optionally the at least three LED's have different colours;
in a fourth zone the audible and/or visible alarm indication means are arranged, such that apertures are provided in the housing in order to emit the audible and/or visible alarm signals;
in a fifth zone three or more legs are provided, such that the device may be placed on said legs on a surface, where the elongated housing is substantially perpendicular to the surface.

In a still further embodiment of the invention, the personal alarm device may be foreseen with one or more light emitting devices arranged in the bottom of the device or integrated in the switch means, such that it may additionally function as a flashlight device. As the device in particular as described as above with respect to the embodiment where the device has five distinct zones has an extremely handy and friendly design, the additional feature of being able to use the device as a flashlight does give the device additional advantages.

In particular in combination with the smoke detector means and the audible/visible alarm indication means, the flashlight option may come in very handy. For example if a fire has broken out in a lodging, the portable personal alarm device will detect this by the smoke detector means. This will cause the audible and/or visible alarm indication means to set off a loud noise and possibly at the same time a stroboscopic light. For the user, this will make it possible easily to detect the whereabouts of the device although smoke may be disorienting the user, the stroboscopic light will guide the user towards the device. Once the user has retrieved the device, the flashlight option will make it easier for the user to find his way towards the fire escape. Therefore, the functionality of having a flash light built into the device may turn out to be a very useful option for such a portable personal alarm device.

In addition to having the smoke detector means, the device may also have gas detection means. The gas detection means are usually constructed such that they require the air containing the gas to pass by the sensor, for example a radioactive isotope which will change electrical characteristics or the like when contacted by certain gasses. For these reasons, the inventive device according to the present invention may be provided with a miniature fan of the types used in computers. Tests have indicated that the heat generated by the power source when the device is put in a substantially upright position may cause the air to move through the device in a “chimney-like” fashion such that air and possibly gas containing air will be sucked in a the bottom of the device, led past the power supply and escape the device around the switch means. This airflow is sufficient and may replace the miniature fan.

In a still further advantageous embodiment, the device may comprise a heat sensor for example in the shape of a heat sensitive resistor such that this sensor in combination with pre-programmed temperature intervals or temperature changes stored in the control circuit may generate the appropriate alarm signals. This is particularly useful for example again in the instance where the user is staying in a lodging and has attached the portable personal alarm device to the door of the lodging. Should a fire occur outside the room where the user is staying, the heat will be transmitted through the door or through the cracks in the door and thereby indicate to the device that an irregular heat increase is present and thereby activate the alarm. In this manner, the personal alarm device will indicate to the user that something unusual is amiss even though smoke has not crept through the door, the temperature increase will indicate that an alarm should be generated.

The device may also comprise a function where the alarm, both visible and audible, is shut off. This may for example be by depressing the switch means for a certain period, for example two seconds.

### DESCRIPTION OF THE DRAWING

The invention will now be explained in more detail with reference to the accompanying drawing wherein

FIG. 1 illustrates a schematic construction of the device,

FIG. 2 illustrates a schematic flow chart of a smoke detector,

FIG. 3 illustrates a schematic flow chart of an instant door alarm,

FIG. 4 illustrates a schematic flow chart of a delayed bag alarm,

FIG. 5 illustrates a schematic flow chart for a personal alarm,

FIG. 6 illustrates a schematic flow chart of a general power alarm,

FIG. 7 illustrates the principle in the vibration sensor,

FIG. 8 illustrates the principle in chamber construction comprising a smoke detector,

FIG. 9 illustrates an embodiment of the invention, and

FIG. 10 illustrates the same as FIG. 9 but not completely assembled.

### DETAILED DESCRIPTION OF THE INVENTION

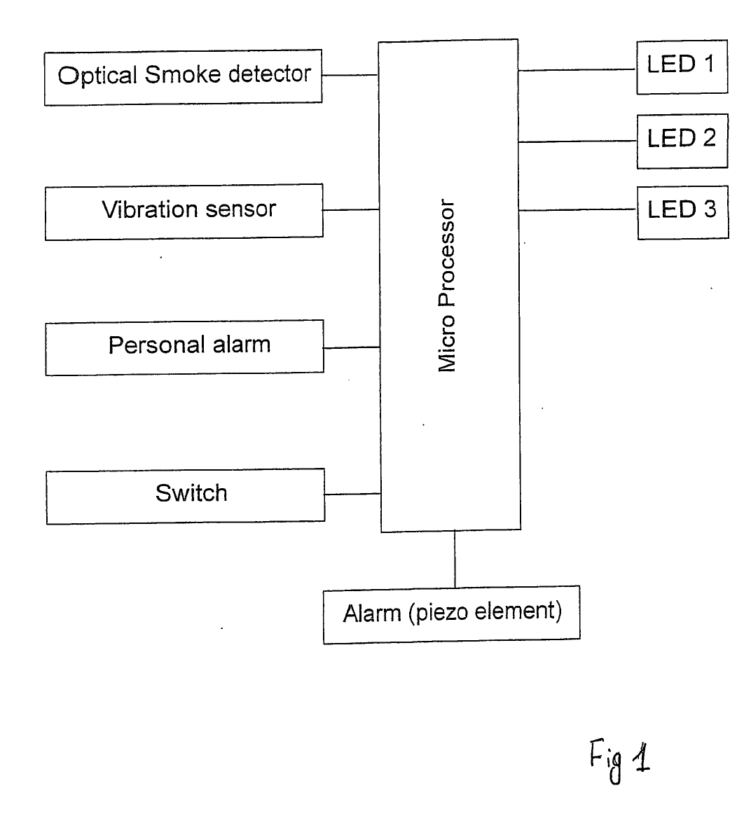

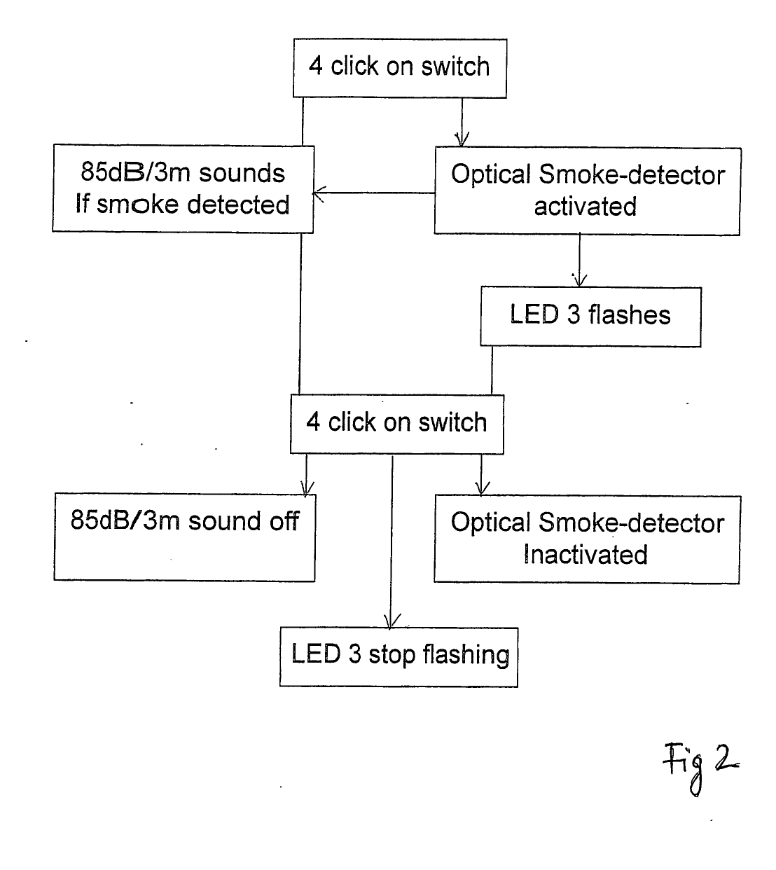

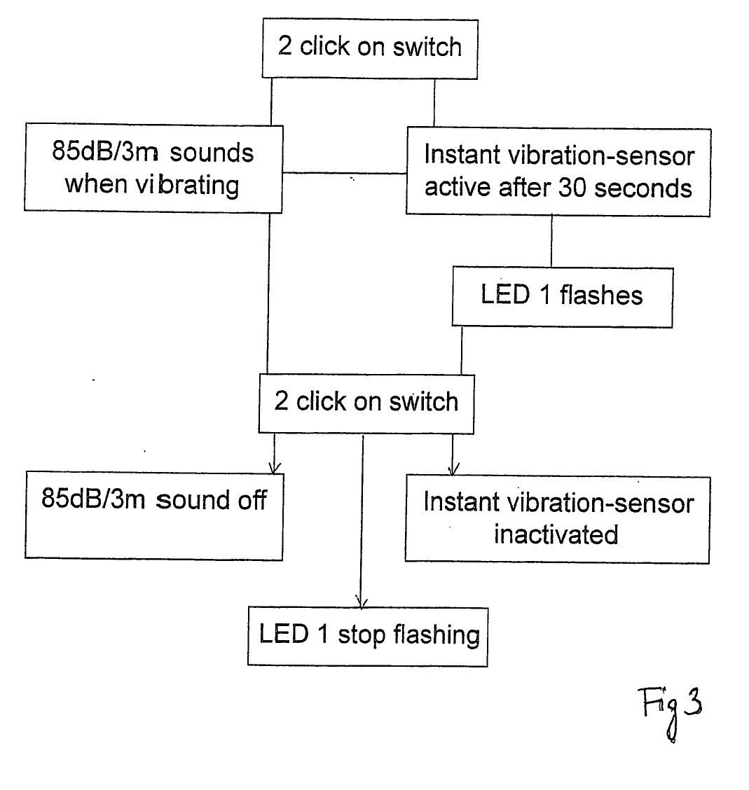

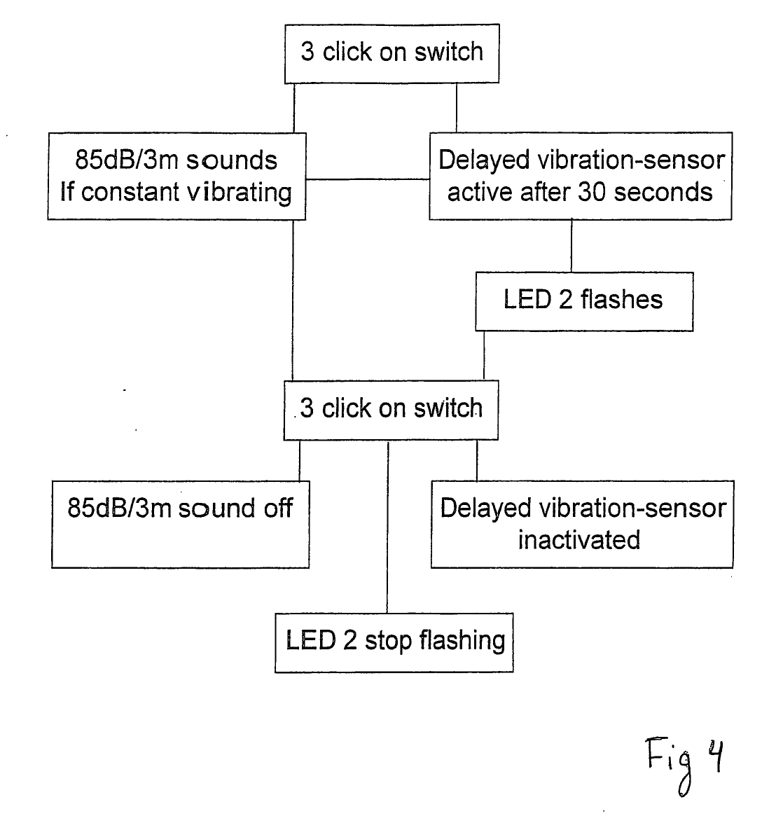

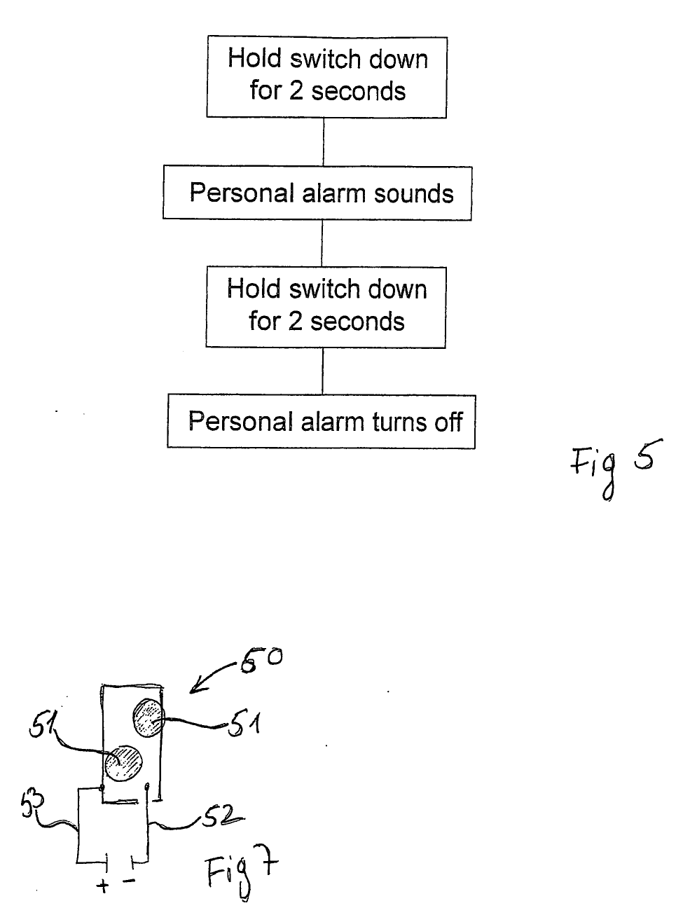

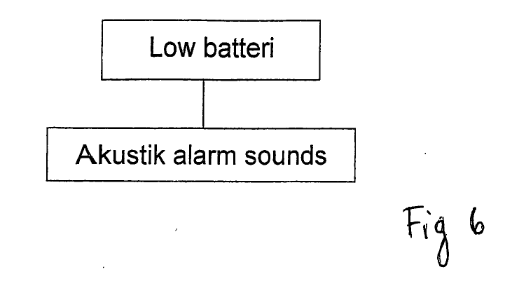

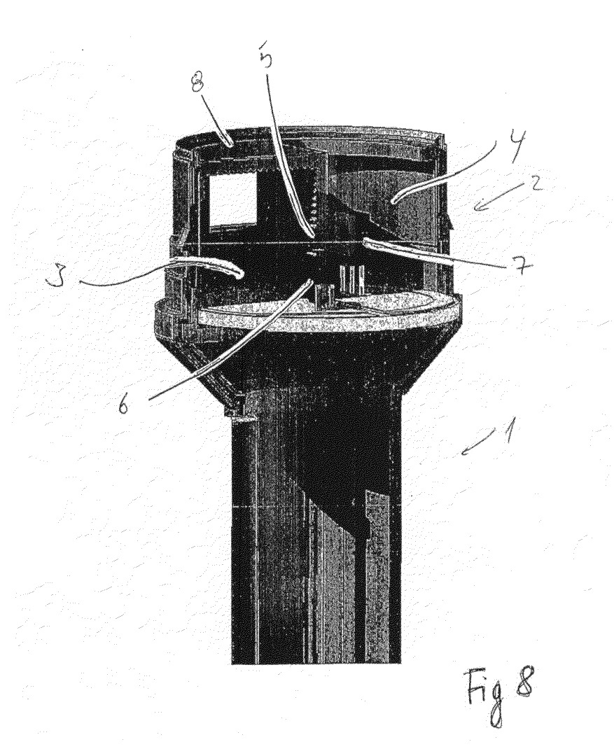

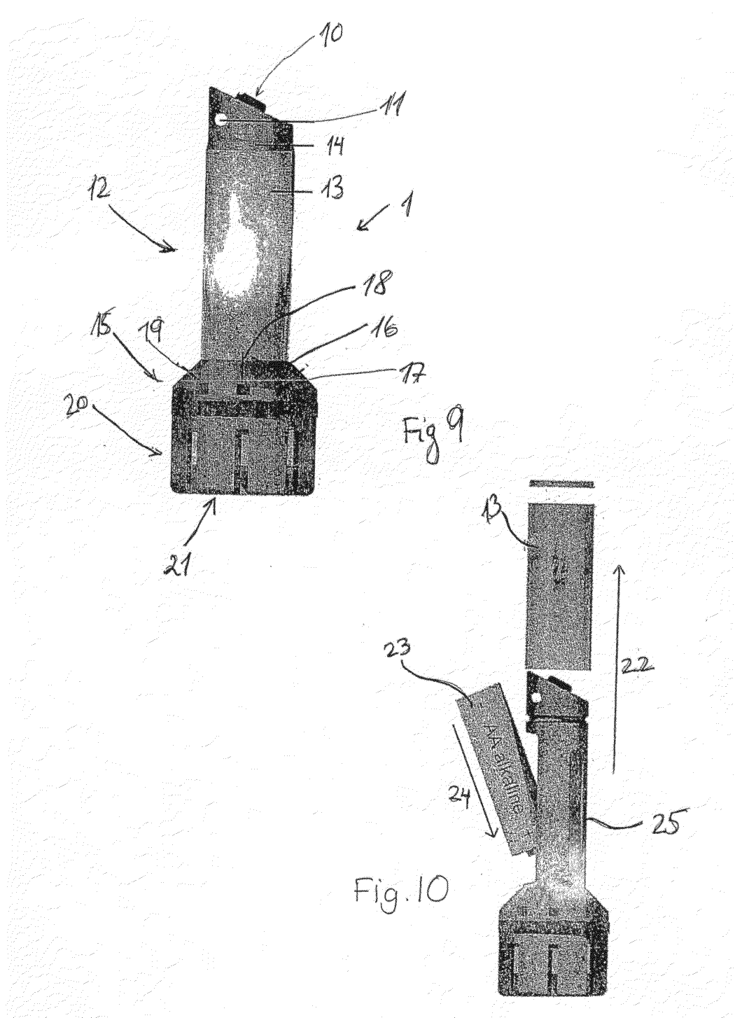

FIG. 1 illustrates a block diagram of the main components of the portable personal alarm device. As is evident from the drawing, the micro processor is connected to most of the features of the device and such is the hop of the device. Below the various detectors and sensors will be explained as well as further embodiments of the invention.

Although the invention will be explained with reference to block diagrams and one particular embodiment as illustrated in FIGS. 9 and 10, it will be evident that a number of physical embodiments of the invention may be contemplated within the scope afforded by the appended claims.

Turning to FIG. 2, a schematic representation is illustrated of how the smoke detector is activated. By depressing the switch 1 four times, the optical smoke detector will be activated, thereby causing LED number 3 to flash. At the same time, an alarm will be generated if smoke is detected, and preferably a noise level corresponding to 85 dB at three meters distance will sound. By again activating the switch by clicking it four times, the optical smoke detector will be inactivated, the LED number 3 will stop flashing and the sound will be turned off.

Turning to FIGS. 3 and 4, the routine for initiating the device as either an instant door alarm or a bag alarm will be quickly explained. By activating the switch means twice as depicted in FIG. 3, an instant alarm may be generated. The vibration sensor which will be explained with reference to FIG. 7 will be active after a delay of 30 seconds. The 30 second delay is chosen such that the bag or suitcase or whatever item, the bag alarm is placed in, may come to a complete rest before the vibration sensor may activate the alarm. As the instant vibration sensor is active, LED number 1 flashes. At the same time if vibrations are registered, the alarm will again sound with a very loud noise. By activating the switch means two more times again, the instant vibration sensor will be inactivated and at the same time, the alarm will be turned off or disconnected.

The door alarm mode is initiated by a different number of clicks and indicated for example by a different LED, combination of LEDs or the hue of the LEDs.

Turning to FIG. 5, how the personal alarm is activated is illustrated. The personal alarm is for use in situations where the user may feel threatened or where the user for one or the other reason wants to activate the alarm instantly for example during a purse robbery, mugging or the like. In this situation, the switch means is depressed for approximately two seconds, after which the alarm sounds. The alarm sound is again the very loud noise of 85 dB or more at three meters distance. In order to switch the personal alarm off again, the switch means should be depressed for a period of two seconds again, after which the personal alarm is turned off.

Turning to FIG. 6, the functionality of indicating low battery is illustrated such that an acoustic alarm preferably different from the very loud 85 dB noise is activated. Alternatively, one or more LEDs may flash in order to indicate to the user that it is time to either recharge or replace the battery.

In FIG. 7, one possible schematic construction of a vibration sensor is illustrated. In a chamber 50, two balls 51 are arranged. The chamber is at least on the inside provided with a conductive material which is connected to one pole of the power source by means of the conductive lead 53. Electrically isolated from the chamber and the lead 53, a second conductive member 52 is placed which is connected to the opposite pole of the power source. The balls 51 are also made from a conductive material such that when a ball such as both the first lead and the second conductive member 52,53, a short circuit will be registered at the power source. This may tricker the vibration sensor outwards such that an alarm is generated. By means of the micro processor, see for example FIG. 1, the vibration sensor as depicted in FIG. 7 may be programmed such that a number of short circuits shall be registered within a certain period of time in order for an alarm to be generated. In this connection, eight short circuits per second have been found to be a substantially secure proof that the device is being moved.

Furthermore in FIG. 8, a cross section through the smoke sensor device is depicted wherein the device 1 in one end is provided with a chamber 2. The chamber is a light trap, and the chamber is constructed such that a light sensor 7 is not able to detect the light emitted from a light source 6. If/when smoke enters the chamber 2, the particles will reflect the light such that the light sensor 8 will register the light and thereby activate the alarm.

The light sensor may be coupled to the micro processor such that the light intensity from the ambient light is compensated for, and only the increase in light intensity due to the reflections from the smoke particles is registered.

The chamber is in this embodiment split in two halves 3,4 where the first half 3 is provided with apertures such that air unhindered may pass through the device in this chamber 3. Between the chamber 3 and the chamber 4, an aperture 5 is provided connecting the chamber 3 with the chamber 4. In the first chamber 3, a light source is furthermore provided, in this example in the shape of a blue diode 6 and the in the second chamber 4, a light sensor 7 is provided. The light sensor 7 will under normal circumstances register the light seeping through the aperture 5 and thereby create a reference light intensity which is stored on the micro processor. As the smoke detector is turned on as explained with reference to FIG. 2, the blue diode 5 will illuminate the chamber 3 and thereby change the light intensity which is registered by the sensor 7. As the smoke detector is activated as explained above with reference to FIG. 2, a new reference will be established for the light intensity registered by the light sensor 7.

In an alternative embodiment, the smoke detector may work the opposite principle, i.e. register the lack of light. If smoke should enter the chamber 3, the light intensity registered by the light sensor 7 will be obscured in that the smoke will partly cloud the aperture 5 such that less light will enter the second chamber 4 and thereby be registered by the light sensor 7. This will cause the smoke detector to activate the alarm as explained above with reference to FIG. 2.

In this description of the embodiments being suitable to be fitted into the illustrated device, a piezo electric loudspeaker element has been selected. This is due to the fact that a piezo electric element will be able to be generated the extremely loud noise which is required in order to create an alarm signal which will serve the purposes as explained above. Another requirement is that the piezo electric element has a very shallow construction height such that it may be integrated into the bottom of the device, for example above the two chambers 3,4 indicated by 8. Finally, the piezo electric element is not very power consuming such that a prolonged alarm sound may be generated in spite of the relatively low power supply present in such a device.

In FIGS. 9 and 10, a preferred embodiment is illustrated providing a design of the device which is suitable to be carried around in a pocket or in any type of luggage. The device 1 comprises in this embodiment five zones. In a first zone, the input means in the shape of a switch means 10 is provided in order for a user to generate the input as explained with reference to FIGS. 1 through 6. Furthermore, an aperture 11 may be provided, in which aperture strap means (not illustrated) may be fastened. By providing for example elastic strap means, the device may be fitted tightly to a door knob or a door handle such that after the vibration sensor means has been activated, any disturbance of the door will cause an alarm to be generated. Disturbance at the door could for example indicate that an intruder is trying to gain access to the room in which the user of the alarm device is present. The second zone indicated by 12 holds the battery as may be seen in FIG. 10. The second zone is covered by a casing 13 which for example may be made from a metal material. Between the first zone and the second zone 12, a resilient member 14 may be provided which will create a certain resistance such that the casing 13 requires a certain force in order to be removed from the device and thereby expose the battery as illustrated in FIG. 10.

In a third zone 15, a cover 16 is provided. The cover may advantageously be made from a plastic material. In the cover, a number of apertures is provided through which the light emitted from LEDs 17,18,19 may be seen. Behind the cover 16, the PCB is on which the LEDs and the microprocessor may be mounted in such a way that the positive pole of the battery is in direct contact with a power pole on the PCB in order to save space.

On the backside of the PCB, i.e. the side turning downwards as depicted in FIG. 9, the smoke detector as illustrated and explained with reference to FIG. 8 may be arranged. The fourth zone is arranged below the third zone and mainly delimits the chambers 3,4 as explained with reference to FIG. 8. The smoke detector described with reference to FIG. 8 is of the optical type, but also radioactive type smoke detectors may be used. A radioactive smoke detector functions by placing a radioactive source which source ionises the smoke particles which ionisation will be detected by a sensor after which an alarm signal will be generated. The radioactive source will not be able to ionise air without smoke particles in that the particle density in clean air is at a level where the sensor will not be able to detect the ionised particles. For smoke however, the density of particles is much higher and therefore a firm indication of the presence of smoke may be sensed by the sensor means.

Also in the fourth zone, gas detection means may be provided. As explained above, gas detection means functions by having a radioactive source which as air and/or gas passes by this source, a sensor placed in the vicinity of the radioactive source will be able to register the chains in radiation due to the presence of gas and thereby generate an alarm signal.

In the fifth zone 21, provided in the very end of the device, the piezo electric element is placed and the fifth zone therefore comprises a number of apertures such that the noise generated by the piezo electric element in response to a generated alarm signal will be able to be emitted through these apertures to the surrounding environment.

Turning to FIG. 10, the assembly/disassembly of the device in order to gain access to the battery source is illustrated. By moving the casing 13 in a direction as indicated by the arrow 22, the battery 23 will be exposed. The battery may be inserted as indicated by the arrow 24, and after the battery 23 has been correctly placed inside the battery holder 25 which at the same time functions as the internal carrying structure giving strength to the entire device, the casing may be brought down in a direction opposite to the direction indicated by the arrow 22 such that the device will have an appearance as indicated in FIG. 9.

The functionality of the device and in particular the manner in which the different inventive features of the invention are activated/deactivated has been explained in an exemplary manner for example may the sequence, number, duration and light indicator means be programmed in different sequences and combinations.

Although the invention has been explained above with reference to a specific embodiment, it is clear to the skilled person that other designs, modifications and other types of sensors may be arranged inside the inventive device without departing from the scope of protection as afforded by the appended claims.

1. Portable personal alarm device comprising:
a manually activable switch means;
a smoke and/or gas detector means;
a vibration and/or tilt detection means;
an audible and/or visible alarm indication means;
a power source; and
a control circuit where input from said switch means, said smoke and/or gas detector means are compared to predetermined relevant values and/or ranges and where said control circuit in response to input from said switch means, said smoke and/or gas detector means may activate said audible and/or visible alarm indication means by activating the corresponding means in the proper mode.

2. Alarm device according to claim 1 wherein the manually activable switch means may be biased towards a rest position and when manually depressed an input is registered, and further such that the control circuit may be programmed in a manner where different input may be generated by the number of times the switch means are activated.

3. Alarm device according to claim 2 wherein a single depression may activate the audible and/or visible alarm, and that optionally the activation may be delayed 1 sec. to 5 sec. after depressing the switch means, or alternatively a longer depression of the switch means for example lasting 2 seconds or more will activate the audible and/or visible alarm.

4. Alarm device according to claim 1 wherein the audible alarm may be a loudspeaker, for example a piezo electrical element, where said audible alarm emits noise corresponding to a loudness of 85 dB at 3 meters distance.

5. Alarm device according to claim 1 wherein a GPS transponder is provided, such that when the switch means has created the correct input in order to activate the vibration and/or tilt detection means the GPS transponder is activated.

6. Alarm device according to claim 1, wherein the visible alarm indication means may be a stroboscopic light source, a flashing laser diode or other suitable low voltage light emitting device.

7. Alarm device according to claim 1 wherein an audible signal is generated each time the switch means are activated and/or one or more LED's are illuminated corresponding to the number of times the switch means are activated.

8. Alarm device according to claim 1 wherein the control circuit may comprise a power monitoring circuit, such that an alarm, either audible or visible, is generated when the power level is below a certain predefined limit.

9. Alarm device according to claim 1 wherein the device is arranged in a housing in the general shape of an elongated cylinder, where said cylinder may have a constant cross section or may have varying cross shape, wherein said cylinder is divided into five distinct zones, wherein
in a first zone the switch means are arranged where a portion of said means extends outside said cylinder, and where optionally a LED may be arranged in the switch means;
in a second zone the power source and necessary control circuitry is arranged, and where optionally the second zone is delimited by a circular cylinder in which cylinder one or more LED's may optionally be provided such that illumination of said LED's may be detected from the outside indicating the mode of the device;
in a third zone three or more LED's are provided in a cap member, which cap member is a transition collar between the second zone and the fourth zone, and that optionally the at least three LED's have different colours;
in a fourth zone the audible and/or visible alarm indication means are arranged, such that apertures are provided in the housing in order to emit the audible and/or visible alarm signals;
in a fifth zone three or more legs are provided, such that the device may be placed on said legs on a surface, where the elongated housing is substantially perpendicular to the surface.

10. Alarm device according to claim 1 wherein the power source is rechargeable, and that recharging means may be provided separately.

11. Alarm device according to claim 1 wherein one or more light emitting devices are arranged in the bottom of the device or integrated in the switch means, such that it may additionally function as a flashlight device.

12. Alarm device according to claim 1 wherein a thermocouple is arranged in the device in order to register the ambient temperature and changes in the ambient temperature.
